(19) United States
(12) Patent Application Publication
(10) Pub. No.: US 2016/0270157 A1
(43) Pub. Date: Sep. 15, 2016

(54) HEAT INSULATION MATERIAL INSTALLATION DEVICE

(71) Applicant: Beomseok HEO, Gyeonggi-do (KR)

(72) Inventor: Beomseok HEO, Gyeonggi-do (KR)

(21) Appl. No.: 15/036,057

(22) PCT Filed: Nov. 12, 2014
(86) PCT No.: PCT/KR2014/010829

§ 371 Date: May 11, 2016

(30) Foreign Application Priority Data
Nov. 12, 2013 (KR) 10-2013-0136801
Jun. 19, 2014 (KR) 10-2014-0075249

(51) Int. Cl. H05B 3/06; H05B 3/16; E04B 1/68; E04B 1/78; E04B 1/76

(52) U.S. Cl. CPC H05B 3/06; E04B 1/78; E04B 1/7608; E04B 1/68; H05B 3/16

(57) ABSTRACT

The present invention relates to a heat insulation material installation device and, more particularly, to a heat insulation material installation device wherein, during dryvit installation, which is an external thermal insulation method, various types of joints are directly installed on thermal insulation materials such that no separate PVC joints need to be installed, materials and labor costs can be reduced, the joints are prevented from being damaged or contaminated during lithic painting, thereby making installation convenient, and the thermal insulation materials can be cut without using hot wires, thereby making the work convenient and preventing accidents. The aforementioned present invention is characterized in that the device comprises: a heating part having a heating element adapted to generate heat through application of power thereto and a controller adapted to set a temperature of the heating element through a bimetal embedded therein to turn the power on/off according to the set temperature; a body disposed on the underside of the heating part and having an installation surface to which the heat generated from the heating element is transmitted; and a handle part having a handle mounted on top of the installation surface of the body to pressurize the body thereagainst.

### TECHNICAL FIELD

The present invention relates to a thermal insulation material joint installation device and, more particularly, to a thermal insulation material joint installation device wherein, during dryvit installation, which is an external thermal insulation method, various types of joints are directly installed on a thermal insulation material, such that no separate PVC joints need to be installed and the joints are prevented from being damaged or contaminated during lithic painting, thereby making installation convenient, and the thermal insulation material is cut without using hot wires, thereby making the work convenient and preventing safety accidents.

### BACKGROUND ART

Generally, a building is constructed to install a thermal insulation material on the exterior wall surface thereof so as to prevent the generation of heat loss and then to finish the exterior thereof with finish materials. This system is called dryvit system.

According to the dryvit system, impurities are first removed from a concrete exterior wall, adhesive resin mortar is applied to the concrete exterior wall, a thermal insulation material is attached to the concrete exterior wall and then cured, a mesh is attached to the exterior wall of the thermal insulation material, pointed joints are installed on the thermal insulation material, and lastly, the finish materials are attached or sprayed.

However, it is not convenient to install the pointed joints on the thermal insulation material, and thus, there is proposed a plastic joint as disclosed in Korean Utility Model Registration No. 414914.

The conventional plastic joint is simple in configuration and easy in manufacturing, thus having a low manufacturing cost. Further, the conventional plastic joint is easy in installation, good in outer appearance and does not have any contamination problems caused by painting.

However, the conventional plastic joint is restricted in the width and depth thereof, thus having limitations in the formation of patterns on the exterior wall.

After the installation of the plastic joints, furthermore, the plastic joints may be easily contaminated, and thus, if lithic spray painting is conducted, the depths of the plastic joints are reduced to cause the lithic spray painting to be conducted even to the plastic joints, so that the plastic joints may disappear, thus making it hard to restore the plastic joints to their original state.

So as to conduct the lithic spray painting for the exterior wall because of the contamination of the exterior wall, accordingly, the PVC joints are detached from the exterior wall, and after they are installed again, next, the painting is conducted. As a result, the installation is very inconvenient, and a large number of materials are consumed.

When the thermal insulation material is installed, on the other hand, there is no tool for cutting the thermal insulation material to an appropriate size, and thus, the thermal insulation material is cut by means of a hot wire. However, if a force is applied to the hot wire so as to melt the thermal insulation material, the hot wire may be easily cut, thus further extending the working time or making a user frequently burnt or hurt. Further, the hot wire may be brought into contact with surrounding insulation materials, thus causing electric shock accidents to happen due to electric leakage.

### DISCLOSURE

### Technical Problem

Accordingly, the present invention has been made in view of the above-mentioned problems occurring in the prior art, and it is an object of the present invention to provide a thermal insulation material joint installation device wherein, during dryvit installation, which is an external thermal insulation method, various types of joints are directly installed on a thermal insulation material through melting of the thermal insulation material, such that no separate PVC joints need to be installed, thus reducing a material cost and a number of operations to allow the number of visits of a worker to be decreased.

It is another object of the present invention to provide a thermal insulation material joint installation device that is capable of preventing joints from being damaged or contaminated during lithic painting, thus making installation convenient, and cutting a thermal insulation material, without using hot wires, thus making the work convenient and protecting a worker from safety accidents.

It is still another object of the present invention to provide a thermal insulation material joint installation device that is capable of freely changing the widths, depths or shapes of joints installed on a thermal insulation material, thus allowing the joints to have various shapes, and deeply installing the joints, so that even if lithic painting is conducted again due to contamination, only the painting is needed, without having the joint installation process.

### Technical Solution

To accomplish the above-mentioned object, according to the present invention, there is provided a thermal insulation material joint installation device including: a heating part having a heating element adapted to generate heat through application of power thereto and a controller adapted to set a temperature of the heating element through a bimetal embedded therein to turn the power on/off according to the set temperature; a body disposed on the underside of the heating part and having an installation surface to which the heat generated from the heating element is transmitted; and a handle part having a handle mounted on top of the installation surface of the body to pressurize the body thereagainst.

According to the present invention, preferably, the installation surface of the body has any one shape selected from a circular arc, a triangular corner, and a square.

According to the present invention, preferably, the body has spiral adjustment rods located on tops of both ends of the installation surface and adjustment plates fixed to the spiral adjustment rods to adjust an installation depth of the installation surface.

According to the present invention, preferably, the body has connection bodies disposed on top of the installation surface thereof in such a manner as to be connected to the lower sides of the handle of the handle part by means of pins to adjust the height of the installation surface through the adjustment of the handle.

According to the present invention, preferably, the body has coupling grooves formed on both sides of the external upper portion of the installation surface thereof and an installation piece having coupling protrusions formed on both upper sides thereof in such a manner as to be inserted into the coupling grooves.

According to the present invention, preferably, the body has a coated surface formed on the external surface of the installation surface thereof.

### Advantageous Effects

According to the present invention, the thermal insulation material joint installation device is configured wherein, during dryvit installation, which is an external thermal insulation method, the joints are directly installed on the thermal insulation material through melting of the thermal insulation material, such that no separate PVC joints need to be installed, thus reducing material and labor costs, the damages or contamination of the joint are prevented during lithic painting, thus making installation convenient, and the joints may be installed in a variety of shapes on the thermal insulation material, thus allowing the joints to be installed to desired shapes.

Further, the thermal insulation material joint installation device according to the present invention is capable of freely changing the widths, depths or shapes of joints installed on the thermal insulation material, thus allowing the joints to have various shapes, and deeply installing the joints, so that even if lithic painting is conducted again due to contamination, only the painting is needed, without having the joint installation process.

The present invention will be described with reference to the particular illustrative embodiments, but it is not to be restricted by the embodiments but only by the appended claims. It is to be appreciated that those skilled in the art can change or modify the embodiments without departing from the scope and spirit of the present invention.

### DESCRIPTION OF DRAWINGS

FIG. 1 is an exploded perspective view showing a thermal insulation material joint installation device according to a first embodiment of the present invention.

FIG. 2 is a perspective view showing the assembled state of the thermal insulation material joint installation device according to the first embodiment of the present invention.

FIG. 3 is a front view showing the thermal insulation material joint installation device according to the first embodiment of the present invention.

FIG. 4 is a side view showing the thermal insulation material joint installation device according to the first embodiment of the present invention.

FIG. 5 is an exploded perspective view showing a thermal insulation material joint installation device according to a second embodiment of the present invention.

FIG. 6 is a perspective view showing the assembled state of the thermal insulation material joint installation device according to the second embodiment of the present invention.

FIG. 7 is a plan view showing the thermal insulation material joint installation device according to the second embodiment of the present invention.

FIG. 8 is a perspective view showing the thermal insulation material joint installation device according to the first embodiment of the present invention, in which an installation piece is adopted.

FIG. 9 is a perspective view showing the joint installation state of the thermal insulation material joint installation device according to the first embodiment of the present invention.

### EXPLANATION ON REFERENCE NUMBERALS IN THE DRAWING

| | |
|---|---|
| 10: heating part | 11: heating element |
| 12: controller | 20: body |
| 21: installation surface | 22: spiral adjustment rod |
| 23: adjustment plate | 24: coupling piece |
| 25: installation piece | 26: coated surface |
| 27: coupling groove | 28: connection body |
| 30: handle part | 31: handle |

### MODE FOR INVENTION

Objects, characteristics and advantages of the present invention will be more clearly understood from the detailed description as will be described below and the attached drawings.

Hereinafter, an explanation on a thermal insulation material joint installation device according to preferred embodiments of the present invention will be in detail given with reference to the attached drawing. The preferred embodiments are provided to describe the present invention in more detail, and accordingly, the technological scope of the present invention is not restricted by the preferred embodiments as discussed below.

### Embodiments

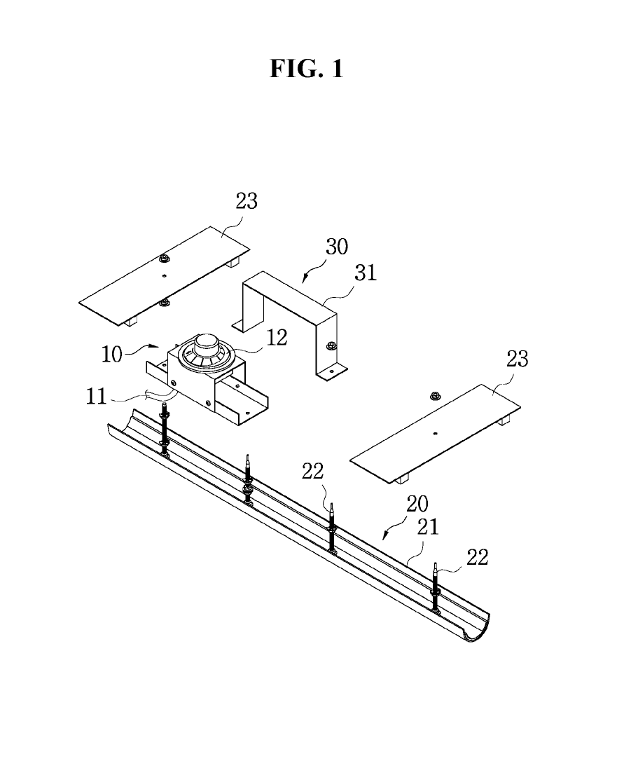

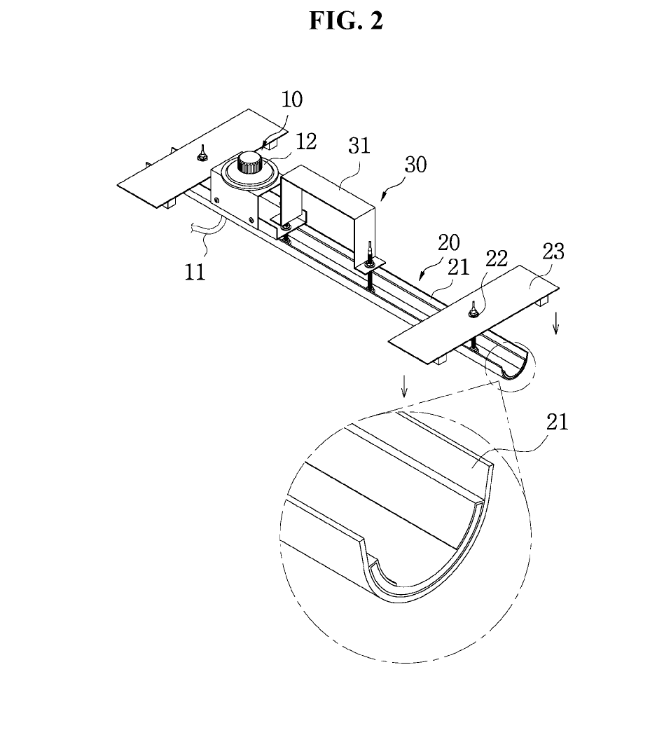

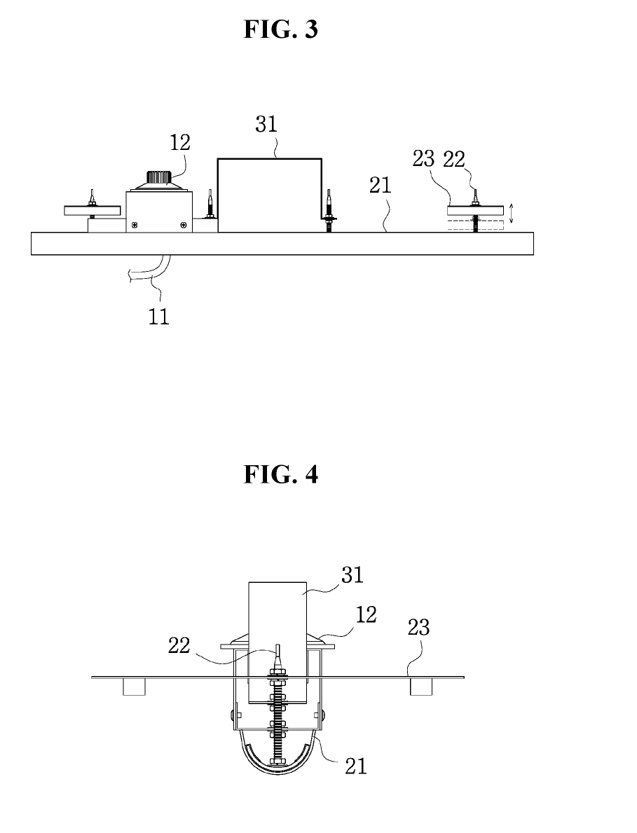

FIG. 1 is an exploded perspective view showing a thermal insulation material joint installation device according to a first embodiment of the present invention, FIG. 2 is a perspective view showing the assembled state of the thermal insulation material joint installation device according to the first embodiment of the present invention, FIG. 3 is a front view showing the thermal insulation material joint installation device according to the first embodiment of the present invention, and FIG. 4 is a side view showing the thermal insulation material joint installation device according to the first embodiment of the present invention.

As shown, a thermal insulation material joint installation device according to a first embodiment of the present invention includes a heating part 100 for generating heat by power to allow a thermal insulation material to be melted, a body 20 to which the heat generated from the heating part 10 is transmitted to melt the thermal insulation material, and a handle part 30 located on the body 20 to allow joints to be installed on the thermal insulation material and to allow the thermal insulation material to be cut.

The heating part 10 has a heating element 11 adapted to generate heat through application of power thereto and a controller 12 for setting a temperature of the heating element 11 and having a bimetal embedded therein to turn the power on/off according to the set temperature.

The heating part 10 is located on top of the body 20, so that the heat generated from the heating element 11 is transmitted to the body 20.

The body 20 has an installation surface 21 to which the heat is transmitted to melt the thermal insulation material, and the installation surface 21 has a variety of shapes such as a circular arc, a triangular corner, and a square according to the kinds of work.

That is, the installation surface 21 has a shape of a square if it is desired to have plane joints of the thermal insulation material, and contrarily, the installation surface 21 has a shape of a circular arc or triangular corner if it is desired to have joints having a triangular groove or a circular groove.

Further, the installation surface 21 is formed with a rectangular steel wire so as to cut the thermal insulation material.

The body 20 has spiral adjustment rods 22 disposed on tops of both ends of the installation surface 21 and adjustment plates 23 fixed to the spiral adjustment rods 22 to adjust an installation depth of the installation surface 21.

The handle part 30 is disposed on top of the installation surface 21 of the body 20 to pressurize the body 20 thereagainst and has a handle 31 mounted on top of the installation surface 21 in such a manner as to be taken by a user's hand.

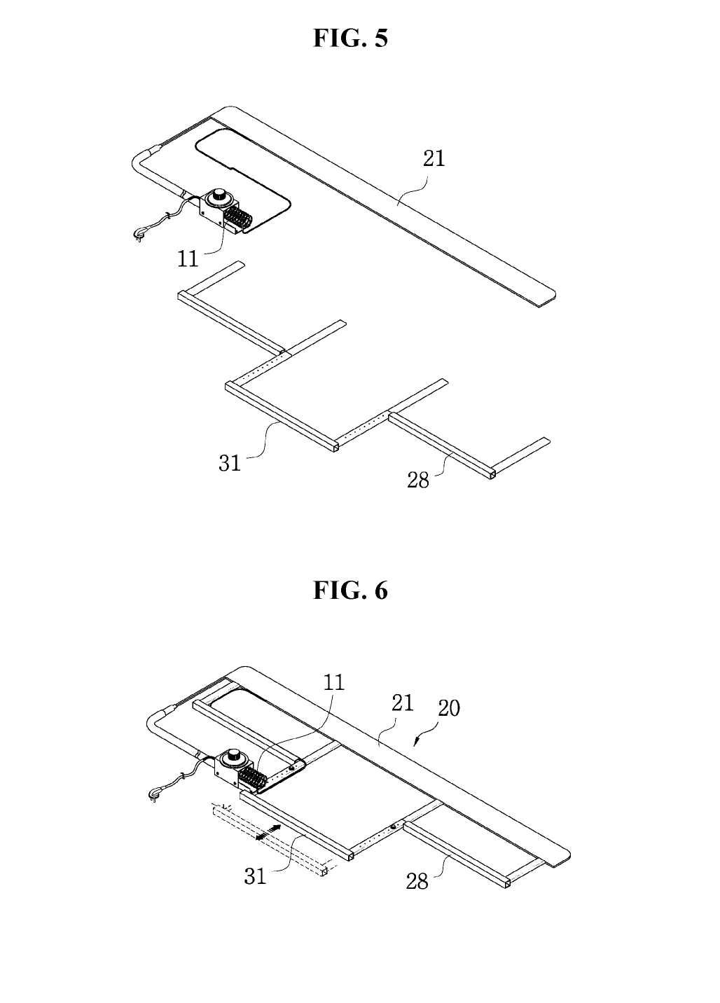

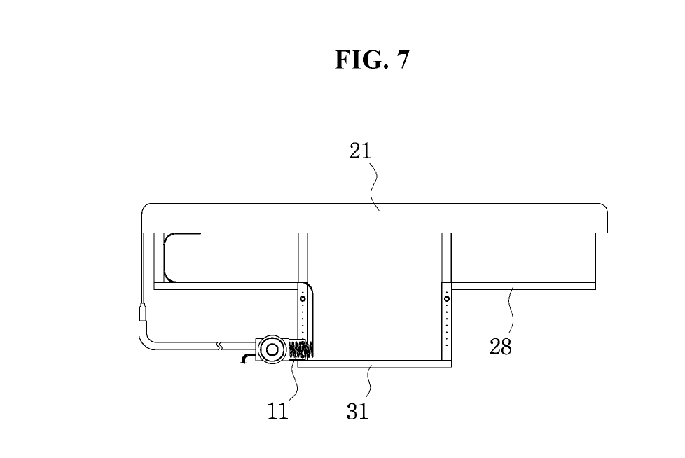

Further, as shown in FIGS. 5 to 7, the body 20 has connection bodies 28 disposed on top of the installation surface 21 thereof in such a manner as to be connected to the lower sides of the handle 31 of the handle part 30 by means of pins to adjust the height of the installation surface 21 through the adjustment of the handle 31.

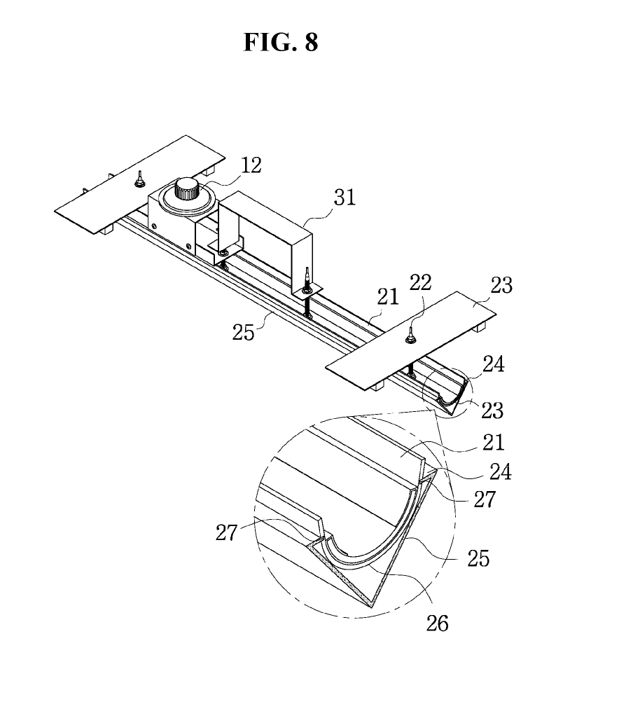

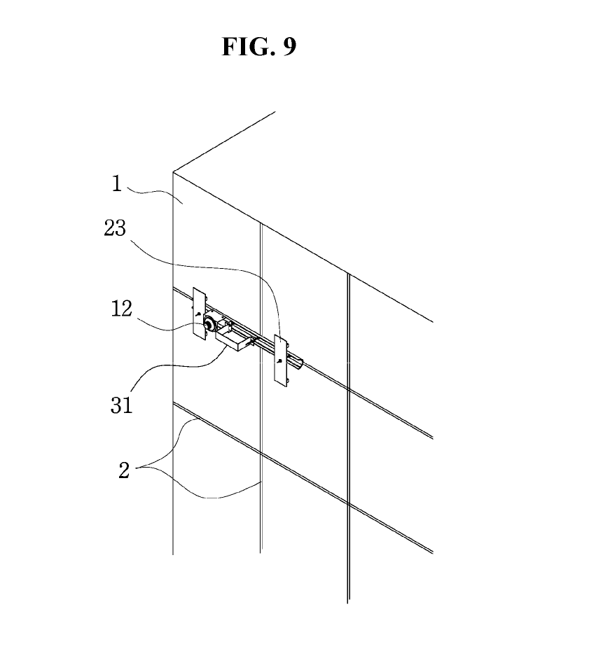

As shown in FIG. 8, the body 20 has coupling grooves 27 formed on both sides of the external upper portion of the installation surface 21 thereof, an installation piece 25 having coupling protrusions 24 formed on both upper sides thereof in such a manner as to be inserted into the coupling grooves 27, and a coated surface 26 formed on the external surface of the installation surface 21 thereof so as to install joints having a variety of shapes as well as to cut the thermal insulation material.

Now, an explanation on the operation and effects of the thermal insulation material joint installation device according to the present invention will be given.

According to a dryvit system, first, impurities are removed from a concrete exterior wall, and adhesive resin mortar is applied to the concrete exterior wall. After that, a thermal insulation material 1 is attached to the concrete exterior wall, joints 2 are installed.

So as to install the joints 2 on the thermal insulation material 1, first, power is applied to the thermal insulation material joint installation device through the controller 12 to raise the temperature of the heating element 11, and next, the heat is transmitted to the installation surface 21 of the body 20, thus increasing the temperature of the installation surface 21 of the body 20.

In this state, if the installation surface 21 comes into contact with the external surface of the thermal insulation material 1 and pressurizes the thermal insulation material 1, the thermal insulation material 1 is melted to install the joints 2.

If the external surface of the thermal insulation material 1 on which the joints 2 are installed is painted with lithic, finishing is completed in the state where the joints 2 are installed on the thermal insulation material 1.

Further, if the heights of the adjustment plates 23 fixed to the spiral adjustment rods 22 disposed on top of the installation surface 21 are adjusted fixedly to the spiral adjustment rods 22, the adjustment plates 23 are surface-contacted with the thermal insulation material 1, thus allowing the depths of the joints 2 installed by melting the thermal insulation material 1 through the installation surface 21 to be constantly maintained.

Furthermore, the thermal insulation material 1 is cut and installed through the installation surface 21, and the height of the handle 31 is adjustable according to the thickness of the thermal insulation material 1.

That is, the connection bodies 28 are disposed on the installation surface 21 in such a manner as to be connected to the handle 31 by means of the pins, thus allowing the height of the handle 31 to be adjustable according to the thickness of the thermal insulation material 1.

On the other hand, the installation surface 21 of the body 20 has the coupling grooves 27 formed longitudinally thereon, so that the installation piece 25 having a variety of shapes is coupled to the installation surface 21 through the coupling protrusions 24 insertedly coupled to the coupling grooves 27, thus allowing the joints 2 to have various widths or sizes and various shapes such as plane joints, round joints, concave joints, struck joints, V joints, convex joints and the like.

1. A thermal insulation material joint installation device, comprising:
a heating part having a heating element adapted to generate heat through application of power thereto and a controller adapted to set a temperature of the heating element through a bimetal embedded therein to turn the power on/off according to the set temperature;
a body disposed on the underside of the heating part and having an installation surface to which the heat generated from the heating element is transmitted; and
a handle part having a handle mounted on top of the installation surface of the body to pressurize the body thereagainst.

2. The thermal insulation material joint installation device according to claim 1, wherein the installation surface of the body has any one shape selected from a circular arc, a triangular corner, and a square.

3. The thermal insulation material joint installation device according to claim 1, wherein the body has spiral adjustment rods located on tops of both ends of the installation surface and adjustment plates fixed to the spiral adjustment rods to adjust an installation depth of the installation surface.

4. The thermal insulation material joint installation device according to claim 1, wherein the body has connection bodies disposed on top of the installation surface thereof in such a manner as to be connected to the lower sides of the handle of the handle part by means of pins to adjust the height of the installation surface through the adjustment of the handle.

5. The thermal insulation material joint installation device according to claim 1, wherein the body has coupling grooves formed on both sides of the external upper portion of the installation surface thereof and an installation piece having coupling protrusions formed on both upper sides thereof in such a manner as to be inserted into the coupling grooves.

6. The thermal insulation material joint installation device according to claim 1, wherein the body has a coated surface formed on the external surface of the installation surface thereof.

7. The thermal insulation material joint installation device according to claim 2, wherein the body has coupling grooves formed on both sides of the external upper portion of the installation surface thereof and an installation piece having coupling protrusions formed on both upper sides thereof in such a manner as to be inserted into the coupling grooves.

8. The thermal insulation material joint installation device according to claim 3, wherein the body has coupling grooves formed on both sides of the external upper portion of the installation surface thereof and an installation piece having coupling protrusions formed on both upper sides thereof in such a manner as to be inserted into the coupling grooves.

9. The thermal insulation material joint installation device according to claim 4, wherein the body has coupling grooves formed on both sides of the external upper portion of the installation surface thereof and an installation piece having coupling protrusions formed on both upper sides thereof in such a manner as to be inserted into the coupling grooves.

10. The thermal insulation material joint installation device according to claim 2, wherein the body has a coated surface formed on the external surface of the installation surface thereof.

11. The thermal insulation material joint installation device according to claim 3, wherein the body has a coated surface formed on the external surface of the installation surface thereof.

12. The thermal insulation material joint installation device according to claim 4, wherein the body has a coated surface formed on the external surface of the installation surface thereof.
